(19) United States
(12) Patent Application Publication
(10) Pub. No.: US 2015/0142756 A1
(43) Pub. Date: May 21, 2015

(54) DEDUPLICATION IN DISTRIBUTED FILE SYSTEMS

(71) Applicants: Mark Robert Watkins, Bristol (GB); Boris Zuckerman, Marblehead, MA (US); Oskar Y. Batuner, Newton, MA (US)

(72) Inventors: Mark Robert Watkins, Bristol (GB); Boris Zuckerman, Marblehead, MA (US); Oskar Y. Batuner, Newton, MA (US)

(21) Appl. No.: 14/117,761

(22) PCT Filed: Jun. 14, 2011
(86) PCT No.: PCT/US2011/040316

§ 371 Date: Nov. 14, 2013

(51) Int. Cl. G06F 17/30

(52) U.S. Cl. CPC G06F 17/30159; G06F 17/30094
USPC 707/692

(57) ABSTRACT

Deduplication in a distributed file system is described. Key classes are determined from a set of potential keys, the potential keys used to represent file content stored by the file system. Control of the key classes is apportioned among index nodes of the file system. Nodes in the file system, during deduplication of data chunks of the file content, generate keys calculated from the data chunks. The keys are distributed among the index nodes based on relations between the keys and the key classes controlled by the index nodes.

### BACKGROUND

Computer networks can include storage systems that are used to store and retrieve data on behalf of computers on the network. In some storage systems, particularly large-scale storage systems (e.g., those employing distributed segmented file systems), it is common for certain items of data to be stored in multiple places in the storage system. For example, data duplication can occur when two or more files have some data in common, or where a particular set of data appears in multiple places within a given file. In another example, data duplication can occur if the storage system is used to back up data from several computers that have common files. Thus, storage systems can include the ability to “deduplicate” data, which is the ability to identify and remove duplicate data.

### BRIEF DESCRIPTION OF THE DRAWINGS

Some embodiments of the invention are described with respect to the following figures:

FIG. 1 is a block diagram of a file system according to an example implementation;

FIG. 2 is a flow diagram showing a method of deduplication in a distributed file system according to an example implementation;

FIG. 3 is a flow diagram showing a method of apportioning control of key classes among index nodes according to an example implementation;

FIG. 4 is a block diagram depicting an indexing operation according to an example implementation;

FIG. 5 is a block diagram depicting a representative indexing operation according to an example implementation;

FIG. 6 is a block diagram depicting a node in a distributed file system according to an example implementation;

FIG. 7 is a block diagram depicting a node in a distributed file system according to another example implementation; and

FIG. 8 is a flow diagram showing a method of determining a key class distribution according to an example implementation.

### DETAILED DESCRIPTION

De-duplication in distributed file systems is described. In an embodiment, key classes are determined from a set of potential keys. The potential keys are those that could be used to represent file content in the file system. Control of the key classes is apportioned among index nodes of the file system. Nodes in the file system deduplicate data chunks of file content (e.g., portions of data content, as described below). During deduplication, the nodes generate keys calculated from the data chunks. The keys are distributed among the index nodes based on relations between the keys and the key classes controlled by the index nodes. Various embodiments are described below by referring to several examples.

A distributed file system can be scalable, in some cases massively scalable (e.g., hundreds of nodes and storage segments). Keeping track of individual elements of file content for purposes of deduplication in an environment having a large number of storage segments controlled by a large number of nodes can be challenging. Further, a distributed file system is designed to be capable of scaling up linearly by growing storage and processing capacities on demand. Example file systems described herein provide for deduplication capability that can scale along with the distributed file system. The knowledge of existing items of file content (e.g., keys calculated from data chunks) is decentralized and distributed over multiple index nodes, allowing the distributed knowledge to grow along with other parts of the file system with additional resources.

In a distributed file system, the number of distinct data chunks and associated keys can be very large. Multiple nodes in the system continuously generate new file data that has to be deduplicated. In example implementations described herein, the full set of potential keys that can represent data chunks of file content is divided deterministically into subsets of keys or “key classes.” Control of the key classes is distributed over multiple index nodes that communicate with nodes performing deduplication. As the number of unique keys calculated from data chunks increases, and/or as the number of nodes performing deduplication increases, the number of index nodes can be increased and control of the key classes redistributed to balance the indexing load. Example implementations may be understood with reference to the drawings below.

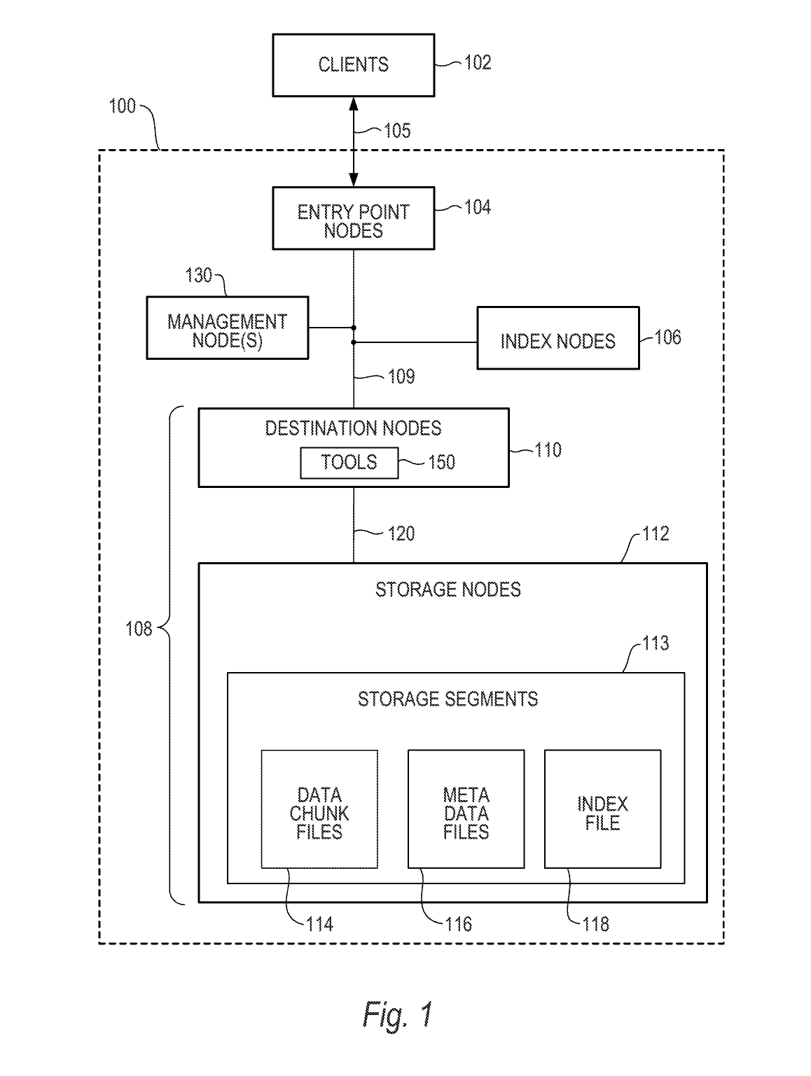

FIG. 1 is a block diagram of a file system 100 according to an example implementation. The file system 100 includes a plurality of nodes. The nodes can include entry point nodes 104, index nodes 106, destination nodes 110, and storage nodes 112. The nodes can also include at least one management node (“management node(s) 130”). The destination nodes 110 and the storage nodes 112 form a storage subsystem 108. The storage nodes 112 can be divided logically into portions referred to as “storage segments 113”. For purposes of clarity by example the nodes of the file system are described in plural to represent a practical distributed segmented file system. In a general example implementation, some nodes of the file system 100 can be singular, such as at least one entry point node, at least one destination node, and/or at least one storage node. The nodes in the file system 100 can be implemented using at least one computer system. A single computer system can implement all of the nodes, or the nodes can be implemented using multiple computer systems.

The file system 100 can serve clients 102. The clients 102 are sources and consumers of file data. The file data can include files, data streams, and like type data items capable of being stored in the file system 100. The clients 102 can any type of device capable of sourcing and consuming file data (e.g., computers). The clients 102 communicate with the file system 100 over a network 105. The clients 102 and the file system 100 can exchange data over the network 105 using various protocols, such as network file system (NFS), server message block (SMB), hypertext transfer protocol (HTTP), file transfer protocol (FTP), or like type protocols. To store file data, the clients 102 send the file data to the file system 100.

The entry point nodes 104 manage storage and deduplication of the file data in the file system 100. The entry point nodes 104 provide an “entry” for file data into the file system 100. The entry point nodes 104 are generally referred to herein as deduplicating or deduplication nodes. The entry point nodes 104 can be implemented using at least one computer (e.g., server(s)). The entry point nodes 104 determine data chunks from the file data. A “data chunk” is a portion of the file data (e.g., a portion of a file or file stream). The entry point nodes 104 can divide the file data into data chunks using various techniques. In an example, the entry point nodes 104 can determine every N bytes in the file data to be a data chunk, In another example, the data chunks can be of different sizes. The entry point nodes 104 can use an algorithm to divide the file data on “natural” boundaries to form the data chunks (e.g., using a Rabin fingerprinting scheme to determine variable sized data chunks). The entry point nodes 104 also generate keys calculated from the data chunks. A “key” is a data item that represents a data chunk (e.g., a fingerprint for a data chunk). The entry point nodes 104 can generate keys for the data chunks using a mathematical function. In an example, the keys are generated using a hash function, such as MD5, SHA-1, SHA-256, SHA-512, or like type functions.

To perform deduplication, the entry point nodes 104 obtain knowledge of which of the data chunks are duplicates (e.g., already stored by the storage subsystem 108). To obtain this knowledge, the entry point nodes 104 communicate with the index nodes 106. The entry point nodes 104 send indexing requests to the index nodes 106. The indexing requests include the keys representing the data chunks. The index nodes 106 respond to the entry point nodes 104 with indexing replies. The indexing replies can indicate which of the data chunks are duplicates, which of the data chunks are not yet stored in the storage subsystem 108, and/or which of the data chunks should not be deduplicated (reasons for not deduplicating are discussed below). Based on the indexing replies, the entry point nodes 104 send some of the data chunks and associated file metadata to the storage subsystem 108 for storage. For duplicate data chunks, the entry point nodes 104 can send only file metadata to the storage subsystem 108 (e.g., references to existing data chunks). In some examples, the entry point nodes 104 can send data chunks and associated file metadata to the storage subsystem 108 without performing deduplication. The entry point nodes 104 can decide not to deduplicate some data chunks based on indexing replies from the index nodes 106, or on information determined by the entry point nodes themselves. In an example, if the keys of two data chunks are candidate data chunks for deduplication, the entry point nodes 104 can perform a full data compare of each data chunk to confirm that the data chunks are actually duplicates.

The index nodes 106 control indexing of data chunks stored in the storage subsystem 108 based on keys. The index nodes 106 can be implemented using at least one computer (e.g., server(s)). The index nodes 106 maintain a key database storing relations based on keys. At least a portion of the key database can be stored by the storage subsystem 108. Thus, the index nodes 106 can communicate with the storage subsystem 108. In an example, a portion of the key database is also stored locally on the index nodes 106 (example shown below). The index nodes 106 receive indexing requests from the entry point nodes 104. The index nodes 106 obtain keys calculated for data chunks being deduplicated from the indexing requests. The index nodes 106 query the key database with the calculated keys, and generate indexing replies from the results.

The destination nodes 110 manage the storage nodes 112. The destination nodes 110 can be implemented using at least one computer (e.g., server(s)). The storage nodes 112 can be implemented using at least one non-volatile mass storage device, such as magnetic disks, solid-state devices, and the like. Groups of mass storage devices can be organized as redundant array of inexpensive disks (RAID) sets. The storage segments 113 are logical sections of storage within the storage nodes 112. At least one of the storage segments 113 can be implemented using multiple mass storage devices (e.g., in a RAID configuration for redundancy).

The storage segments 113 store data chunk files 114, metadata files 116, and index files 118. A particular storage segment can store data chunk files, metadata files, or index files, or any combination thereof. A data chunk file stores data chunks of file data. A metadata file stores file metadata. The file metadata can include pointers to data chunks, as well as other attributes (e.g., ownership, permissions, etc.). The index files 118 can store at least a portion of the key database managed by the index nodes 106 (e.g., an on-disk portion of the key database).

The destination nodes 110 communicate with the entry point nodes 104 and the index nodes 106. The destination nodes 110 provision and de-provision storage in the storage segments 113 for the data chunk files 114, the metadata files 116, and the index files 118. The destination nodes 110 communicate with the storage nodes 112 over links 120. The links 120 can include direct connections (e.g., direct-attached storage (DAS)), or connections through interconnect, such as fibre channel (FC), Internet small computer simple interface (iSCSI), serial attached SCSI (SAS), or the like. The links 120 can include a combination of direct connections and connections through interconnect.

In an example, at least a portion of the entry point nodes 104, the index nodes 106, and the destination nodes 110 can be implemented using distinct computers communicating over a network 109. The nodes can communicate over the links 109 using various protocols. In an example, processes on the nodes can exchange information using remote procedure calls (RPCs). In an example, some nodes can be implemented on the same computer (e.g., an entry point node and a destination node). In such case, nodes can communicate over the links 109 using a direct procedural interface within the computer.

As noted above, the entry point nodes 104 generate keys calculated from data chunks of file content. The function used to generate the keys should have preimage resistance, second preimage resistance, and collision resistance. The keys can be generated using a hash function that produces message digests having a particular number of bits (e.g., the SHA-1 algorithm produces 160-bit messages). Hence, there is a universe of potential keys that can be calculated for data chunks (e.g., SHA-1 includes 2̂160 possible keys). In an example, the universe of potential keys is divided into subsets or classes of keys (“key classes”). Dividing a set of possible keys into deterministic subsets can be achieved by various methods. For example, assuming generation of keys from file content creates an even distribution of values, key classes can be identified by a particular number of bits (N bits) from a specified position in the message (e.g., N most significant bits, N least significant bits, N bits somewhere in the middle of the message whether contiguous or not, etc.). In such a scheme, the set of possible keys is divided into 2̂N key classes.

In another example, key classes can be generated by identifying keys that are more likely to be generated from the file data (e.g., likely key classes). The key classes can be generated using a static analysis, heuristic analysis, or combination thereof. A static analysis can include analysis of file data related to known operating systems, applications, and the like to identify data chunks and consequent keys that are more likely to appear (e.g., expected keys calculated from expected file content). A heuristic analysis can be performed based on calculated keys for data chunks of file content over time to identify key classes that are most likely to appear during deduplication. An example heuristic can include identifying keys for well-known data patterns in the file data. In another example, key classes can be generated based on some Pareto of the data chunks under management (e.g., key classes can be formed such that k % if the keys belong to (100-k) % of key classes, where k is between 50 and 100). In general, the universe of keys can be divided into some number of more likely key classes and at least one less likely class. In such a scheme, each key class may not represent the same number of keys (e.g., there may be some number of more likely key classes and then a single larger key class for the rest of the keys).

In yet another example, the key classes may not collectively represent the entire universe of potential keys. In such cases, key classes may be “representative key classes,” since not every key in the universe will fall into a class. For example, if the universe of potential keys can be divided into 2̂N key classes using an N-bit identifier, then only a portion of such key classes may be selected as representative key classes. Heuristic analysis such as those described above may be performed to determine more likely key classes, with keys that are less likely not represented by a class. For example, if a Pareto analysis indicates that 80% of the keys belong to 20% of the key classes, only those 20% of key classes can be used as representative.

In general, key classes are determined from the set of potential keys forming a “key class configuration.” Regardless of the key class configuration, control of the key classes is apportioned among the index nodes 106 (a “key class distribution”). Each of the index nodes 106 can control at least one of the key classes. The entry point nodes 104 maintain data indicative of the distribution of key class control among the index nodes 106 (“key class distribution data”). The entry point nodes 104 distribute indexing requests among the index nodes 106 based on relations between the keys and the key classes as determined from the key class distribution data. The entry point nodes 104 identify which of the index nodes 106 are to receive certain keys based on the key class distribution data that relates the index nodes 106 to key classes.

In an example, the management node(s) 130 control the key class configuration and key class distribution in the file system 100. The management node(s) 130 can be implemented using at least one computer (e.g., server(s)). A user can employ the management node(s) 130 to establish a key class configuration and key class distribution. The management node(s) 130 can inform the index nodes 106 and/or the entry point nodes 104 of the key class distribution. In an example, the management node(s) 130 can collect heuristic data from nodes in the file system (e.g., the entry point nodes 104, the index nodes 106, and/or the destination nodes 110). The management node(s) 130 can use the heuristic data to generate at least one key class configuration over time (e.g., the key class configuration can change over time based on the heuristic data). The heuristic data can be generated using an heuristic analysis or heuristic analyses described above.

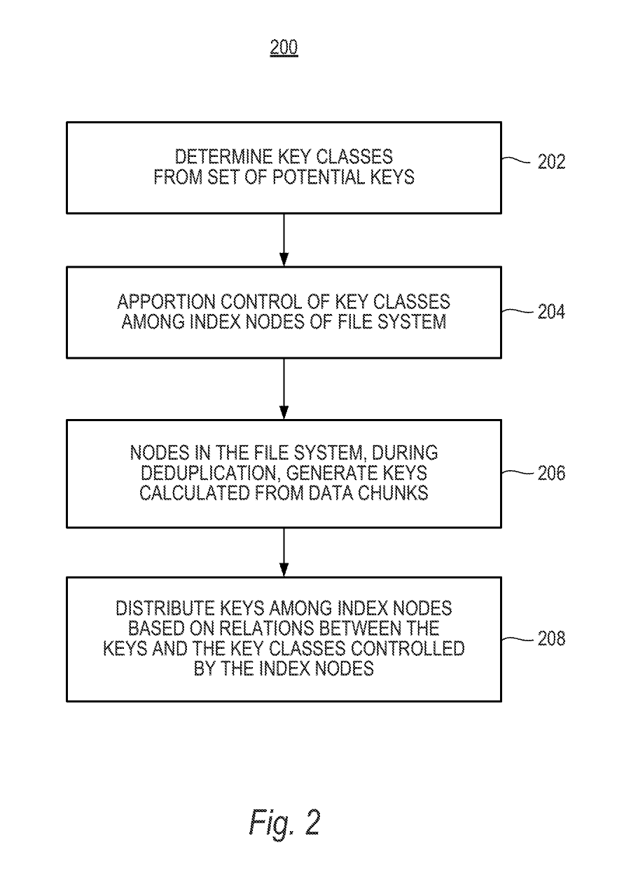

FIG. 2 is a flow diagram showing a method 200 of deduplication in a distributed file system according to an example implementation. The method 200 can be performed by nodes in a file system. The method 200 begins at step 202, where key classes are determined from a set of potential keys. The potential keys are used to represent file content stored by the file system. At step 204, control of the key classes is apportioned among index nodes of the file system. At step 206, nodes in the file system, during deduplication of data chunks of the file content, generate keys calculated from the data chunks. At step 208, the keys are distributed among the index nodes based on relations between the keys and the key classes controlled by the index nodes.

Returning to FIG. 1, control over key classes can be passed from one index node to another for various reasons, such as load balancing, hardware failure, maintenance, and the like. If control over a key class is moved from one index node to another, the index nodes 106 can update the entry point nodes 104 of a change in key class distribution, and the entry point nodes 104 can update respective key class distribution data. The index nodes 106 or a portion thereof can broadcast key class distribution information to the entry point nodes 104, or a propagation method can be used where some entry point nodes 104 can receive key class distribution information from some index nodes 106, which can then be propagated to other entry point nodes and so on. The process of propagating key class distribution information among the entry point nodes 104 can take some period of time. Thus, key class distribution data may be different across entry point nodes 104. If during such a time period an entry point node has a stale relation in its key class distribution data, the entry point node may send an indexing request to an incorrect index node. The index nodes 106, upon receiving incorrect indexing requests, can respond with indexing replies that indicate the incorrect key to key class relation. In such cases, the entry point nodes 104 can attempt to update respective key class distribution data or send the corresponding data chunk(s) for storage without deduplication.

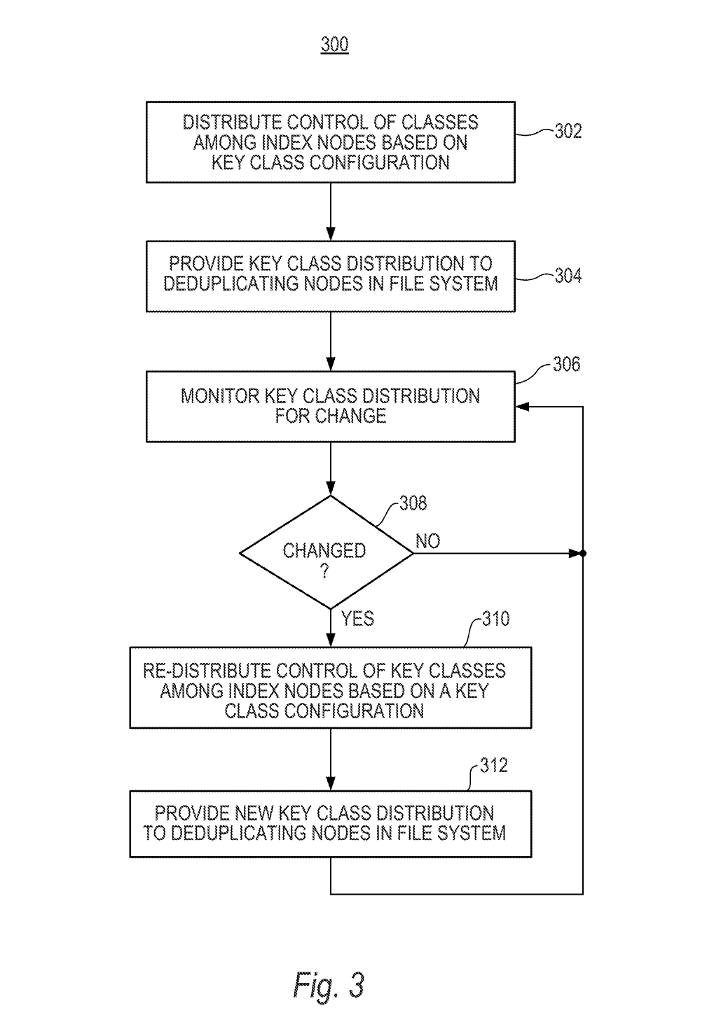

FIG. 3 is a flow diagram showing a method 300 of apportioning control of key classes among index nodes according to an example implementation. The method 300 can be performed by nodes in a file system. The method 300 can be performed as part of step 204 in the method 200 of FIG. 2 to apportion control of key classes among index nodes. The method 300 begins at step 302, where control of key classes is distributed among index nodes based on a key class configuration. At step 304, the key class distribution is provided to deduplicating nodes in the file system (e.g., the entry point nodes 104). At step 306, the key class distribution is monitored for change. For example, control of key class(es) can be moved among index nodes for load balancing, hardware failure, maintenance, and the like. In another example, the key class configuration can be changed (e.g., more key classes can be created, or some key classes can be removed). At step 308, a determination is made whether the key class distribution has changed. If not, the method 300 returns to step 306. If so, the method 300 proceeds to step 310. At step 310, control of key classes is re-distributed among index nodes based on a key class configuration. As noted in step 306, the configuration of index nodes and/or the key class configuration may have changed. At step 312, a new key class distribution is provided to deduplicating nodes in the file system (e.g., the entry point nodes 104). The method 300 then returns to step 306.

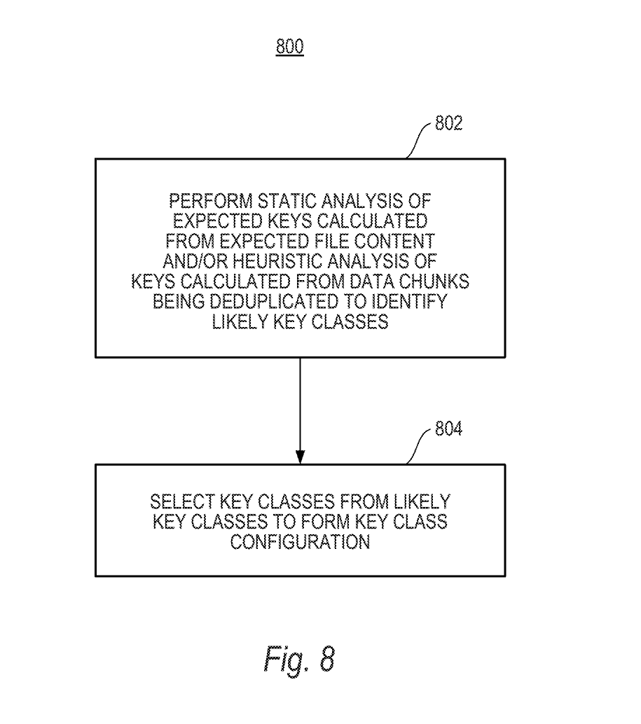

FIG. 8 is a flow diagram showing a method 800 of determining a key class configuration according to an example implementation. The method 800 can be performed by nodes in a file system. The method 800 can be performed as part of step 202 in the method 200 of FIG. 2 to determine key classes from potential keys. The method 800 begins at step 802, where a static analysis and/or heuristic analysis is/are performed to identify likely key classes. A static analysis can be performed on expected file content to generate expected keys. A heuristic analysis can be performed on data chunks being deduplicated and corresponding calculated keys. At step 804, key classes are selected from the likely key classes to form the key class configuration. All or a portion of the key likely key classes can be used to form the key class configuration.

Returning to FIG. 1, in an example key class configuration, the key classes collectively cover the entire universe of potential keys such that every key generated by the entry point servers 104 falls into a key class assigned to one of the index nodes 106. As the entry point nodes 104 generate keys, the keys are matched to key classes and sent to the appropriate ones of the index nodes 106 based on key class.

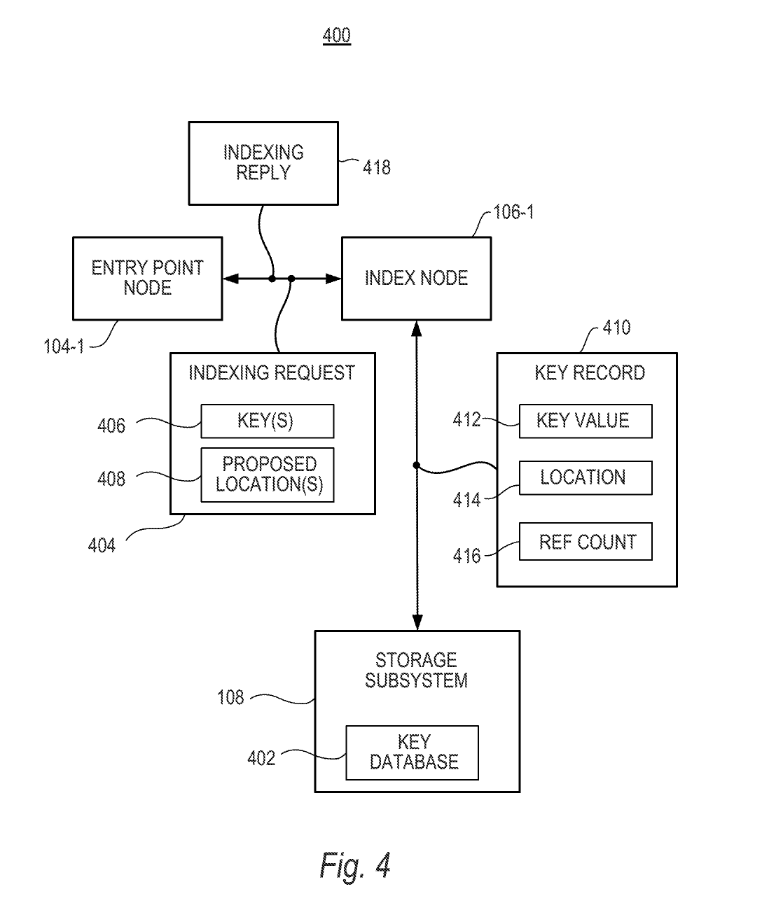

FIG. 4 is a block diagram depicting an indexing operation according to an example implementation. An entry point node 104-1 communicates with an index node 106-1. The index node 106-1 communicates with the storage subsystem 108. The storage subsystem 108 stores a key database 402 (e.g., in the index files 118). The entry point node 104-1 sends indexing requests to the index node 106-1. An indexing request 404 can include key(s) 406 calculated from data chunk(s) of file content, and proposed location(s) 408 for the data chunk(s) within in the storage subsystem 108 (e.g., which of the storage segments 113). The key(s) 406 are within a key class managed by the index node 106-1. The present indexing operation can be performed between any of the entry point nodes 104 and the index nodes 106.

The index node 106-1 queries the key database 402 with the key(s) from the indexing request 404, and obtains query results. For those key(s) 406 not in the key database 402, the index node 106-1 can add such key(s) to the key database 402 along with respective proposed location(s) 408. The key(s) and respective proposed location(s) can be marked as provisional in the key database 402 until the associated data chunks are actually stored in the proposed locations. For each of the key(s) 406 in the key database 402, the query results can include a key record 410. The key record 410 can include a key value 412, a location 414, and a reference count 416. The reference count 416 indicates the number of times a particular data chunk associated with the key value 412 is referenced. The location 414 indicates where the data chunk associated with the key value 412 is stored in the storage subsystem 108. For each key in the key database 402, the index node 106-1 can update the reference count 416 and return the location 414 to the entry point node 104-1 in an indexing reply 418.

Returning to FIG. 1, in another example key class configuration, the key classes do not collectively cover the entire universe of potential keys. The key class configuration can include key classes including keys that are representative keys. Representative indexing assumes that only well known key classes are significant. Only these significant key classes controlled by the index nodes 106. As the entry point nodes 104 generate keys, the keys are matched to key classes. Some of the calculated keys are representative keys having a matching key class. Others of the calculated keys are non-representative keys that do not match any of the key classes in the key class configuration. The entry point nodes 104 group calculated keys into key groups. Each of the key groups includes a representative key. Each of the key groups may also include at least one non-representative key. The entry point nodes 104 send the key groups to the index nodes 106 based on relations between representative keys in the key groups and the key classes.

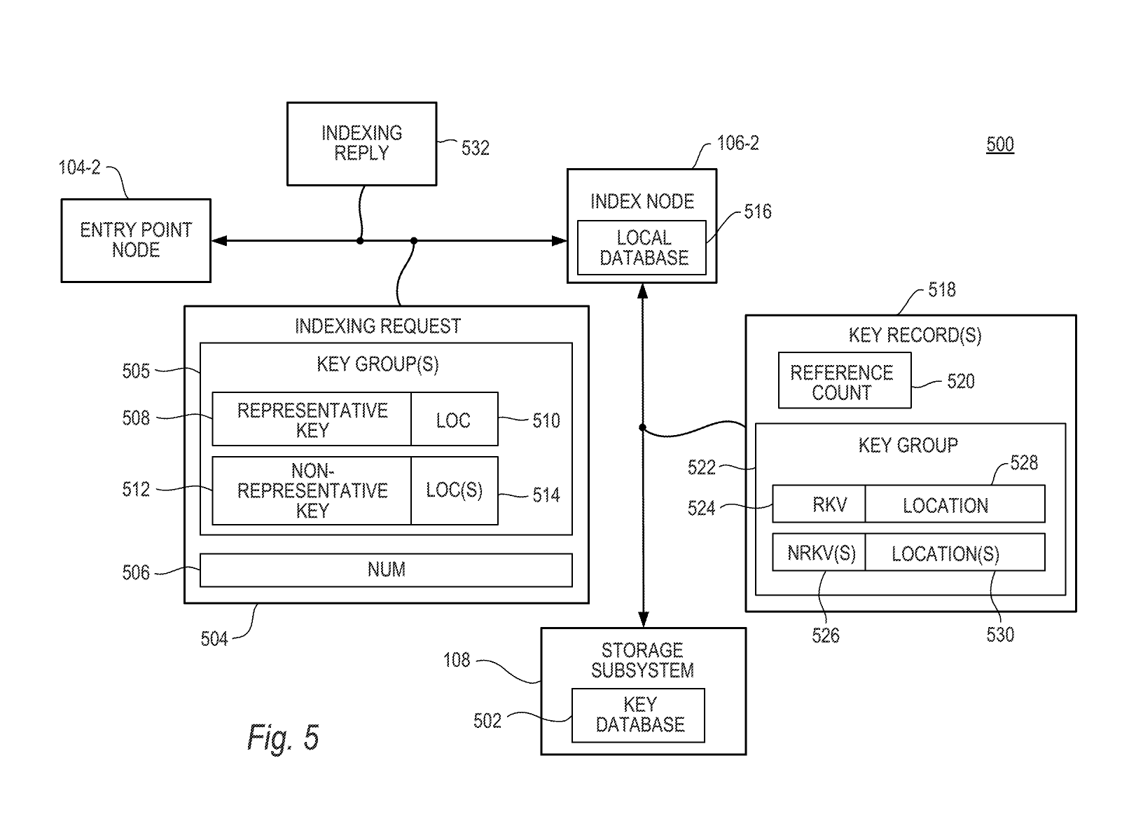

FIG. 5 is a block diagram depicting a representative indexing operation according to an example implementation. An entry point node 104-2 communicates with an index node 106-2. The index node 106-2 communicates with the storage subsystem 108. The storage subsystem 108 stores a key database 502 (e.g., in the index files 118). The entry point node 104-2 sends indexing requests to the index node 106-2. An indexing request 504 can include a key group 505 and an indication of the number of keys in the key group (NUM 506). The key group 505 can include a representative key 508 and at least one non-representative key 512. The key group 505 can also include a proposed location (LOC 510) for the data chunk associated with the representative key 508, and proposed location(s) (LOC(S) 514) for the data chunk(s) associated with the non-representative key(s) 512. The representative key 508 is within a key class managed by the index node 106-2. The present indexing operation can be performed between any of the entry point nodes 104 and the index nodes 106.

In an example, the index node 106-2 can maintain a local database 516 of known representative keys within key class(es) managed by the index node 106-2 (known representative keys being representative keys stored in the key database 502). The index node 106-1 queries the local database 516 with the representative key 508 and obtains query results. If the representative key 508 is in the local database 516, the index node 106-2 queries the key database 502 with the representative key 508 to obtain query results. The query results can include at least one representative key record 518. Each of the representative key record(s) 518 can include a reference count 520 and a key group 522. The reference count 520 indicates how many times the key group 522 has been detected. The key group 522 includes a representative key value (RKV 524) and at least one non-representative key value (NRKV(s) 526). The key group 522 also includes a location 528 indicating where the data chunk associated with the representative key value 524 is stored, and location(s) 530 indicating where the data chunk(s) associated with the non-representative key value(s) 526 is/are stored.

The index node 106-2 attempts the match the key group 505 in the indexing request 504 with the key group 522 in one of the representative key record(s) 518. If a match is found, the index node 106-2 updates the corresponding reference count 520 and returns the location 528 and the location(s) 530 to the entry point node 104-2 in an indexing reply 532. If no match is found, the index node 106-2 attempts to add a representative key record 518 with the key group 505. In some examples, the key database 502 may have a limit on the number of representative key records that can be stored for each known representative key. If a new representative key record 518 cannot be added to the key database 502, then the index node 106-2 can indicate in the indexing reply 532 that the data chunks should be stored without deduplication. If the new representative key record 518 can be added to the key database 502, then reference count 520 is incremented and the key group 505 and respective proposed locations 528 and 530 can be marked as provisional in the key database 502 until the associated data chunks are actually stored in the proposed locations.

If the representative key 508 is not in the local database 516, the index node 106-2 can add a representative key record 518 with the key group 505 to the key database 502. The index node 106-2 also updates the local database 516 with the representative key 508. The key group 505 and respective proposed locations 528 and 530 can be marked as provisional in the key database 502 until the associated data chunks are actually stored in the proposed locations.

Returning to FIG. 1, if representative indexing is employed, the index nodes 106 can maintain several possible combinations of representative and non-representative keys. Given a particular key group, the index nodes 106 do not detect whether the same non-representative key has been seen before in combination with another representative key. Thus, there will be some duplication of data chunks in the storage subsystem 108. The amount of duplication can be controlled based on the key class configuration. Maximizing key class configuration coverage of the universe of potential keys minimizes duplication of data chunks in the storage system 108. However, more key class configuration coverage of the universe of potential keys leads to more required index node resources. Representative indexing can be selected to balance incidental data chunk duplication against index node capacity.

In some examples, the entry point nodes 104 can select some data chunks to be stored in the storage subsystem 108 without performing indexing operations and hence without deduplication (“opportunistic deduplication”). This can remove the deduplication process from the write performance path and prevent indexing operations from negatively affecting efficiency of writes. The entry point nodes 104 can implement opportunistic deduplication using a policy based on various factors. In one example, the entry point nodes 104 can perform as heuristic analysis of the responsiveness of indexing replies from the index nodes 106 versus the responsiveness of the storage subsystem 108 storing data chunks. In another example, the entry point nodes 104 can track a ratio of newly seen to already known data chunks.

For example, some of the most attractive cases for deduplication are cloning of virtual machines. Such cloning originally creates complete duplicates of data. Later, as the virtual machines are actively used, the probability of seeing file data that could be deduplicated is lower. The entry point nodes 104 can learn, self-adjust, and eliminate deduplication attempts and associated penalties using opportunistic deduplication.

As noted above, data chunks can be distributed through multiple storage segments 113. This allows sufficient throughput for placing new data in the storage subsystem 108. The entry point nodes 104 can decide which of the storage segments 113 should be used to store data chunks. In some examples, file data that includes data written to different files within a narrow time window can be placed into different storage segments 113. In some examples, entry point nodes 104 can distribute data chunks belonging to the same file or stream across several of the storage segments 113. Thus, the entry point nodes 104 can implement various RAID schemes by directing storage of data chunks across different storage segments 113. The destination nodes 110 can provide a service to the entry point nodes 104 that atomically pre-allocates space and increases the size of data chunk files.

In some examples, the destination nodes 110 can implement various tools 150 that maintain elements of the deduplicated environment. The tools can scale with the number of storage segments 113 and the number of key classes in the key class configuration. For example, the deduplication process performed by the entry point nodes 104 can be referred to as “in-line deduplication”, since the deduplication is performed as the file data is received. The destination nodes 110 can include an offline deduplication tool that scans the storage nodes 112 and performs further deduplication of selected files. The offline deduplication tool can also reevaluate and deduplicate data chunks that were left without deduplication through decisions by the entry point nodes 104 and/or the index nodes 106. The tools 150 can also include dcopy and dcmp utilities to efficiently copy and compare deduplicated files without moving or reading data. The tools 150 can include a replication tool for creating extra replicas of data chunk files, index files, and/or metadata files to increase availability and accessibility thereof. The tools 150 can include a tiering migration tool that can move data chunk files, index files, and metadata files to a specified set of storage segments. For example, index files can be moved to storage segments implemented using solid state mass storage devices for quicker access. Data chunk files that have not been accessed within a certain time period can be moved to storage segments implemented using spin-down disk devices. The tools 150 can include a garbage collector that removes empty data chunk files.

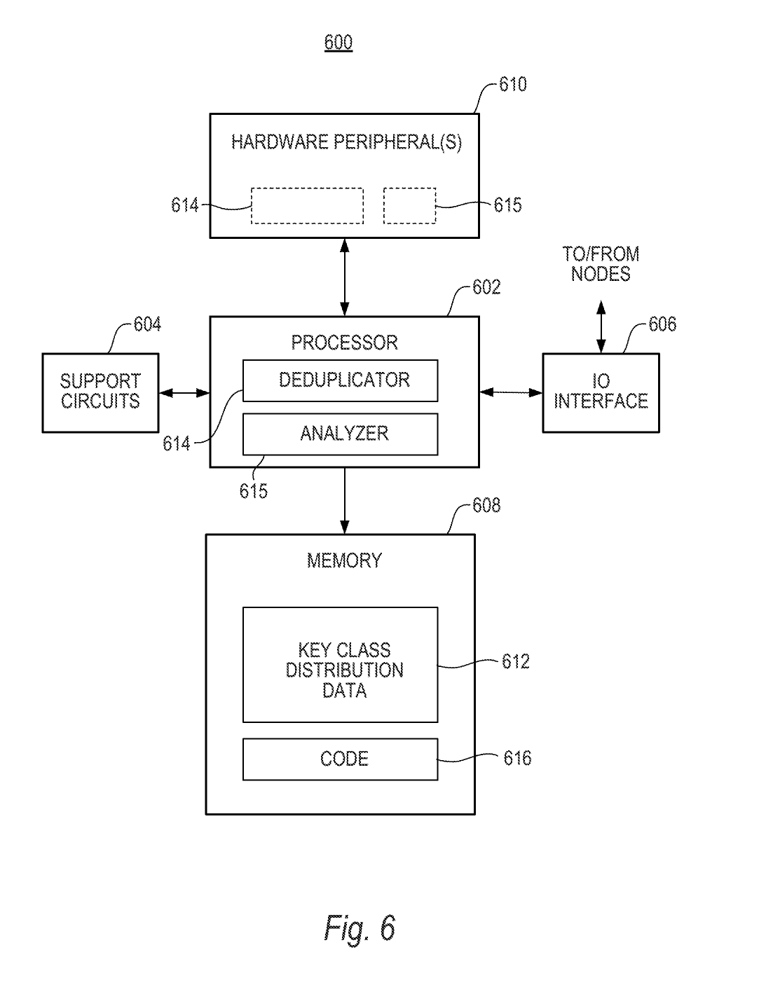

FIG. 6 is a block diagram depicting a node 600 in a distributed segmented file system according to an example implementation. The node 600 can be used to perform deduplication of file data. For example, the node 600 can implement an entry point node 104 in the file system 100 of FIG. 1. The node 600 includes a processor 602, an IO interface 606, and a memory 608. The node 600 can also include support circuits 604 and hardware peripheral(s) 610. The processor 602 includes any type of microprocessor, microcontroller, microcomputer, or like type computing device known in the art. The support circuits 604 for the processor 602 can include cache, power supplies, clock circuits, data registers, IO circuits, and the like. The IO interface 606 can be directly coupled to the memory 608, or coupled to the memory 608 through the processor 602. The memory 608 can include random access memory, read only memory, cache memory, magnetic read/write memory, or the like or any combination of such memory devices. The hardware peripheral(s) 610 can include various hardware circuits that perform functions on behalf of the processor 602.

The IO interface 606 receives file data, communicates with a storage subsystem, and communicates with index nodes. The memory 608 stores key class distribution data 612. The key class distribution data 612 includes relations between index nodes and key classes. The key classes are determined from a set of potential keys used to represent file content.

In an example, the processor 602 implements a deduplicator 614 to provide the functions described below. The processor 602 can also implement an analyzer 615. The memory 608 can store code 616 that is executed by the processor 602 to implement the deduplicator 614 and/or analyzer 615. In some examples, the deduplicator 614 and/or analyzer 615 can be implemented as a dedicated circuit on the hardware peripheral(s) 610. For example, the hardware peripheral(s) 610 can include a programmable logic device (PLD), such as a field programmable gate array (FPGA), which can be programmed to implement the functions of the deduplicator 614 and/or analyzer 615.

The deduplicator 614 receives the file data from the IO interface 606. The deduplicator 614 determines data chunks from the file data, and generates keys calculated from the data chunks. The deduplicator 614 distributes (through the IO interface 606) the keys among the indexing nodes based on the key class distribution data 612. For example, the deduplicator 614 can match keys to key classes, and then identify index nodes that control the key classes from the key class distribution data 612. The deduplicator 614 deduplicates the data chunks for storage in the storage subsystem based on responses from the indexing nodes. For example, the indexing nodes can respond with which of the data chunks are already known and which are not known and should be stored. The deduplicator 614 can selectively send the data chunks to the storage subsystem based on the responses from the index nodes.

In some examples, the deduplicator 614 groups the keys into key groups. Each of the key groups includes a representative key that is a member of a key class. Key group(s) can also include at least one non-representative key that is not a member of a key class. The deduplicator 614 can send the key groups to the index nodes based on representative keys of the key groups and the key class distribution data 612. For example, the deduplicator 614 can match representative keys to key classes, and then identify index nodes that control the key classes from the key class distribution data 612.

In some examples, the deduplicator 614 implements opportunistic deduplication. The deduplicator 614 can select certain data chunks from the file data and send such data chunks to the storage subsystem to be stored without deduplication. Aspects of opportunistic deduplication are described above.

The analyzer 615 can collect statistics on the keys calculated from data chunks being deduplicated. The analyzer 615 can perform a heuristic analysis of the statistics to generate heuristic data. The heuristic data can be used to identify likely key classes that can form a key class configuration. Various heuristic analyses have been described above. The analyzer 615 can process the heuristic data itself. In another example, the analyzer 615 can send the heuristic data to other node(s) (e.g., the management node(s) 130 shown in FIG. 1) that can use the heuristic data to determine a key class configuration.

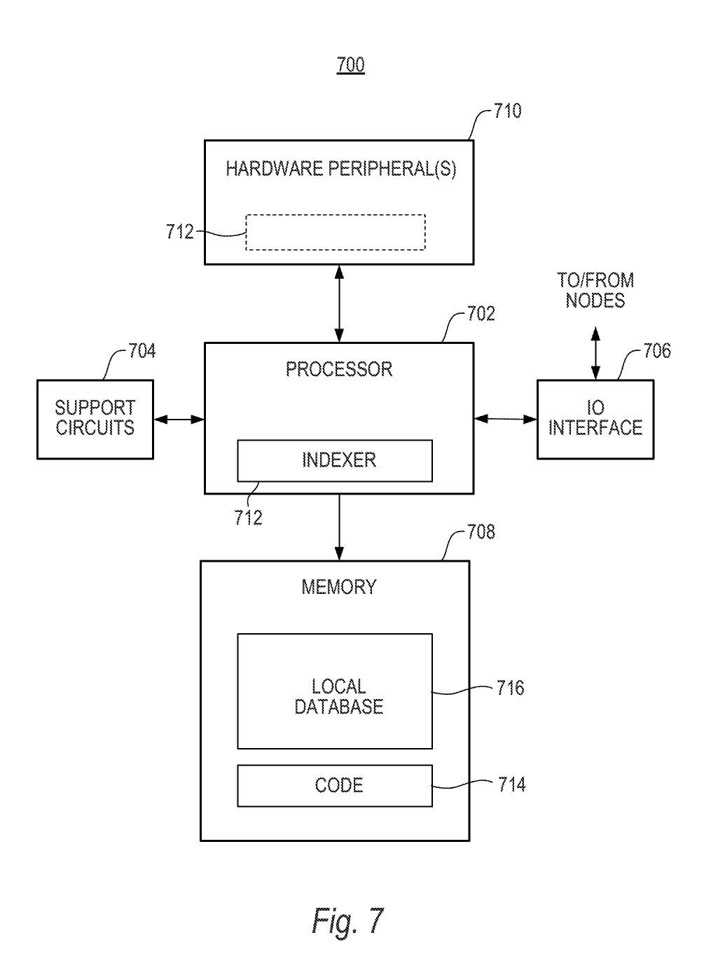

FIG. 7 is a block diagram depicting a node 700 in a distributed segmented file system according to an example implementation. The node 700 can be used to perform indexing services for deduplicating file data. For example, the node 700 can implement an index node 106 in the file system 100 of FIG. 1. The node 700 includes a processor 702 and an IO interface 706. The node 700 can also include a memory 708, support circuits 704, and hardware peripheral(s) 710. The processor 702 includes any type of microprocessor, microcontroller, microcomputer, or like type computing device known in the art. The support circuits 704 for the processor 702 can include cache, power supplies, clock circuits, data registers, IO circuits, and the like. The IO interface 706 can be directly coupled to the memory 708, or coupled to the memory 708 through the processor 702. The memory 708 can include random access memory, read only memory, cache memory, magnetic read/write memory, or the like or any combination of such memory devices. The hardware peripheral(s) 710 can include various hardware circuits that perform functions on behalf of the processor 702.

The IO interface 706 communicates with a storage subsystem that stores at least a portion of a key database. The IO interface 706 receives indexing requests from deduplicating nodes. The indexing requests can include calculated keys for data chunks being deduplicated. The calculated keys are members of a key class assigned to the node. The key class in one of a plurality of key classes determined from a set of potential keys.

In an example, the processor 702 implements an indexer 712 to provide the functions described below. The memory 708 can store code 714 that is executed by the processor 702 to implement the indexer 712. In some examples, the indexer 712 can be implemented as a dedicated circuit on the hardware peripheral(s) 710. For example, the hardware peripheral(s) 710 can include a programmable logic device (PLD), such as a field programmable gate array (FPGA), which can be programmed to implement the functions of the indexer 712.

The indexer 712 receives the indexing requests from the IO interface 706 and obtains the calculated keys. The indexer 712 queries the key database to obtain query results. The query results can include, for example, information indicative of whether calculated keys are known. The indexer 712 sends responses (through the IO interface 706) to the deduplicating nodes based on the query results to provide deduplication of the data chunks for storage in the storage system.

In an example, the calculated keys in the indexing request can be grouped into key groups. Each of the key groups includes a representative key that is a member of the key class assigned to the node. Key group(s) can also include at least one non-representative key that is not part of any of the key classes. The indexer 712 can obtain key records from the key database based on representative keys of the key groups. In an example, each of the key records can include values for each representative and non-representative key therein, and locations in the storage subsystem for data chunks associated with each representative and non-representative key therein. In an example, the storage subsystem stores a first portion of the key database, and the memory 708 stores a second portion of the key database (a “local database 716”). The local database 716 includes representative keys for data chunks stored by the storage subsystem.

De-duplication in distributed file systems has been described. The knowledge of existing items of file content (e.g., keys calculated from data chunks) is decentralized and distributed over multiple index nodes, allowing the distributed knowledge to grow along with other parts of the file system with additional resources. In example implementations, the full set of potential keys that can represent data chunks of file content is divided into key classes. The key classes can cover all of the universe of potential keys, or only a portion of such key universe. Control of the key classes is distributed over multiple index nodes that communicate with deduplicating nodes. As the number of unique keys calculated from data chunks increases, and/or as the number of nodes performing deduplication increases, the number of index nodes can be increased and control of the key classes redistributed to balance the indexing load. The deduplicating nodes can employ opportunistic deduplication by selectively storing some file content without deduplication to improve write performance.

The methods described above may be embodied in a computer-readable medium for configuring a computing system to execute the method. The computer readable medium can be distributed across multiple physical devices (e.g., computers). The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc., just to name a few. Other new and various types of computer-readable media may be used to store machine readable code discussed herein.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of deduplication in a distributed file system, comprising:
determining key classes from a set of potential keys, the potential keys used to represent file content stored by the file system;
apportioning control of the key classes among index nodes of the file system;
nodes in the file system, during deduplication of data chunks of the file content, generating keys calculated from the data chunks; and
distributing the keys among the index nodes based on relations between the keys and the key classes controlled by the index nodes.

2. The method of claim 1, further comprising:
grouping the keys into key groups, each of the key groups including a representative key that is a member of a respective one of the key classes;
wherein the distributing includes sending the key groups to the index nodes based on relations between representative keys in the key groups and the key classes controlled by the index nodes.

3. The method of claim 1, wherein the step of determining comprises:
performing at least one of a static analysis of expected keys calculated from expected file content or a heuristic analysis of the keys calculated from the data chunks to identify likely key classes; and
selecting the key classes from the likely key classes.

4. The method of claim 1, further comprising:
the index nodes, in response to receiving the keys, sending responses to the nodes to provide deduplication of the data chunks for storage in the file system.

5. The method of claim 1, further comprising:
the nodes in the file system, upon receiving other data chunks of the file content, indicating that the other data chunks should be stored in the file system without deduplication.

6. A node in a distributed file system, comprising:
an input/output (IO) interface to receive file data, communicate with a storage subsystem, and communicate with index nodes;
a memory to store key class distribution data relating key classes to the index nodes, the key classes being determined from a set of potential keys used to represent file content; and
a processor, coupled to the IO interface and the memory, to determine data chunks from the file data, generate keys calculated from the data chunks, distribute the keys among the index nodes based on the key class distribution data, and deduplicate the data chunks for storage in the storage subsystem based on responses from the index nodes.

7. The node of claim 6, wherein the processor groups the keys into key groups, each of the key groups including a representative key that is a member of a respective one of the key classes, and sends the key groups to the index nodes based on representative keys of the key groups and the key class distribution data.

8. The node of claim 7, wherein each of the key groups includes at least one non-representative key that is not a member of any of the key classes.

9. The node of claim 6, wherein the processor receives responses from the index nodes indicating which of the data chunks are duplicates, and selectively sends the data chunks to the storage subsystem to be stored based on the responses.

10. The node of claim 6, wherein the processor determines other data chunks from the file data, and sends the other data chunks to the storage subsystem to be stored without deduplication.

11. A node in a distributed file system, comprising:
an input/output (IO) interface to communicate with a storage subsystem storing at least a portion of a key database, and to receive indexing requests from deduplicating nodes, the indexing requests including calculated keys for data chunks being deduplicated, the calculated keys being members of a key class assigned to the node, the key class being one of a plurality of key classes determined from a set of potential keys; and
a processor, coupled to the IO interface, to generate results by querying the key database with the calculated keys, and to respond to the deduplicating nodes based on the results to provide deduplication of the data chunks for storage in the storage system.

12. The node of claim 11, wherein the calculated keys are grouped into key groups, each of the key groups including a representative key that is a member of the key class assigned to the node and at least one non-representative key that is not a member of any of the key classes.

13. The node of claim 12, wherein the processor obtains key records from the key database based on representative keys of the key groups.

14. The node of claim 13, wherein each of the key records includes values for each representative and non-representative key therein and locations in the storage subsystem for data chunks associated with each representative and non-representative key therein.

15. The node of claim 12, wherein the storage subsystem stores a first portion of the key database, and wherein the node further comprises:
a memory to store a second portion of the key database that includes representative keys for data chunks stored by the storage subsystem.
